(19) United States
(12) Patent Application Publication
(10) Pub. No.: US 2011/0002450 A1
(43) Pub. Date: Jan. 6, 2011

(54) Personalized Caller Identification

(76) Inventors: Yong Hui Dandy FENG, Singapore (SG); Chih Hsing TAO, Singapore (SG)

Correspondence Address: INFINEON TECHNOLOGIES AG;Patent Department, MUC 11.1.507, P.O. Box 221644, Munich, 80506, DE

(21) Appl. No.: 12/497,719

(22) Filed: Jul. 6, 2009

(51) Int. Cl. H04M 1/64

(52) U.S. Cl. 379/88.02

(57) ABSTRACT

This disclosure relates to different systems and methods of indicating a caller identity, e.g. using the caller's voice.

The present disclosure is directed to diverse systems and methods of indicating a caller identity.

### BACKGROUND

Within a telecommunication system, information is transmitted over a distance for purpose of communication. A communication process is usually started by indicating to a recipient that a caller wishes to start a communication procedure. In a traditional telephone system, the indication is achieved by producing a ring tone at the recipient's terminal device, e.g. a telephone. Meanwhile, in modern telecommunication systems, such as modern public telephone systems, mobile telephone communication systems, Voice-over-IP telephone systems, etc., the identity of a caller is indicated by a voice Caller ID, e.g. so to allow showing the telephone number of the caller on a display of the recipient's terminal. This allows the recipient to prepare for replying to an incoming call or to decide whether to accept a call or not.

With the growing use of telecommunication systems in any society, it is getting more and more convenient to a user of a communication device to know the identity of a caller before accepting a call. For these and other reasons, there is a need for the present invention.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a block diagram illustrating an exemplary communication system.

FIG. 2 is a block diagram illustrating an exemplary caller identification method.

FIG. 3 is a block diagram illustrating an exemplary method of creating an information identity record.

FIG. 4 is a block diagram illustrating an exemplary method of creating an information identity record.

### DETAILED DESCRIPTION

This disclosure is directed to systems and methods of indicating a caller identity. More particularly, the techniques involve identifying a caller by referring to characteristics of the caller's voice. The disclosed systems and methods can be implemented in a variety of communication devices or systems. For example, a system or method can be implemented in mobile phones, base stations, etc. They may be used in the context of mobile or wireline communication. They may as well be used in the context of IP telephony or any other suitable communication system. The following systems and methods are described with reference to a mobile communication system; however, it will be appreciated that the disclosed systems and methods can be implemented generally in any electronic communication system.

### Exemplary Systems

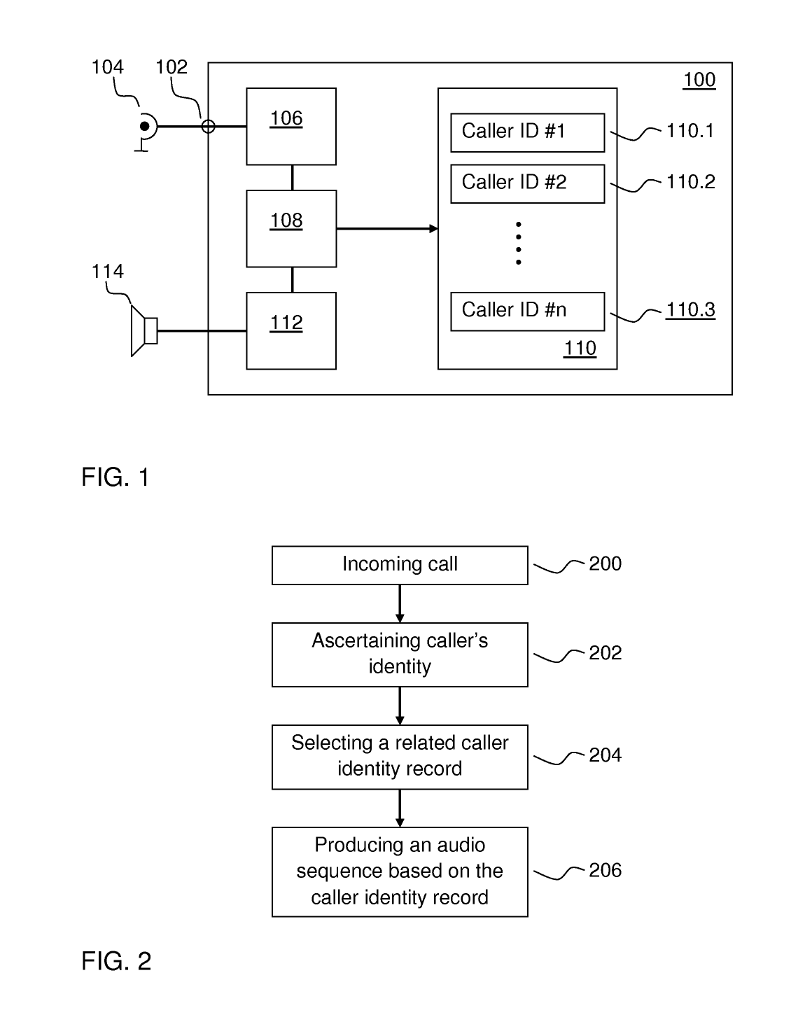

FIG. 1 illustrates a system for indicating a caller identity to be used as part of a communication terminal device 100. The illustration of the system is limited to the functional units related to the technique described in the present disclosure. It is readily apparent to any one skilled in the art, that further elements and functional units may be added or arranged in the context of a communication terminal device.

The communication terminal device 100 comprises a terminal 102 to receive an incoming call signal. The incoming call signal comprises among different other information, such as the ringing signal, the useful information transmitted, etc., a caller identity information (caller ID). The Caller ID may confer information such as the caller's telephone number.

The terminal 102 receives the incoming call signal from an input connector 104, which may connect to a communication channel via an antenna or a plug. The terminal 102 connects to an extraction unit 106 that extracts the Caller ID from the incoming call signal. The extraction unit 106 may be implemented as a microcontroller or digital signal processor that processes the incoming signal and identifies information corresponding to the caller ID. Thus, the extraction unit 106 corresponds to circuitry for ascertaining the caller identity from the Caller ID information.

The extraction unit 106 connects to a selection unit 108 that receives the caller ID. The selection unit 108 couples to a date storage 110 retaining a plurality of Caller ID records 110.1 to 110.3. The date storage 110 may be any suitable implementation of memory, in particular a non-volatile memory, such as a FLASH memory. Each Caller ID record 110.1 to 110.3 comprises information about the caller identity, such as the name, and information regarding characteristics of the caller's voice. E.g., a Caller ID record 110.1 to 110.3 may contain an audio recording of the caller's name or telephone number as voice recording of the caller speaking said name or telephone number. In another embodiment, the Caller ID record 110.1 to 110.3 comprises speech coding parameters representing characteristics of the caller's voice. A possible speech-coding scheme may be based on Code Excited Linear Prediction (CELP) coding. Yet, other speech coding schemes, such as based on μ-law algorithms or Speex codings may be used.

The selection unit 108 selects a related Caller ID record related to the Caller ID information identified by the extraction unit 108. It couples to voice generator 112 and initiates a production of a voice message comprising information of the caller's identity by the voice generator 112. The voice generator 112 connects to a loudspeaker 114 to produce the voice message as audio signal.

In some cases, the selection unit 108 may not select a related Caller ID record in the data storage 110. The reason may be that either no related Caller ID record had been built up so far or that the data storage 110 is filled up due to a limited memory size. On this occasion, the selection unit 108 may start a process to receive the information to be stored as related Caller ID record. This may envolve an automatic communication with the caller to record an audio file, e.g. asking the caller to enunciate his name for a record and linking the recording of the speech production to the caller ID. In another embodiment, the record may be built up by selecting specific speech parameters during a communication of the caller and the user while linking this information to a phone book entry and the caller ID.

The selection unit 108 may be arranged to produce a different Caller ID record, in case the related Caller ID record may not be found, e.g. using a Caller ID record related to the user or to a specific ring tone.

### Exemplary Method

The method introduced may, but need not, be implemented at least partially in architecture(s) such as shown in FIG. 1. In addition, it is to be appreciated, that certain acts in the methods need not be performed in the order described, may be modified, and/or may be omitted entirely. Furthermore, the method may be implemented in any suitable hardware, software, firmware, or a combination thereof, without departing from the scope of the disclosure. E.g. the method may be performed by any suitable system, including a microprocessor, a single or a plurality of communication processors; a digital signal processor, etc.

FIG. 2 illustrates a method for indicating the identity of a caller in a telecommunication system. The process initiates by a step 200 of receiving an incoming call of a caller. The call comprises a Caller ID so to allow for a determination of the caller's identity. In a subsequent step 202, the caller's identity is ascertained accordingly. Based on this information a related caller identity record is selected in step 204. The related caller identity record comprises characteristics of the caller's voice. These characteristics may be comprised by speech coding parameters as well as by an audio record containing a speech sequence spoken by the caller. In a final step 206, an audio sequence based on the record is produced. E.g., a speech generator may produce an audio sequence representing the caller's name using the recorded speech parameters. In a further example, a playback of the recorded audio sequence is performed.

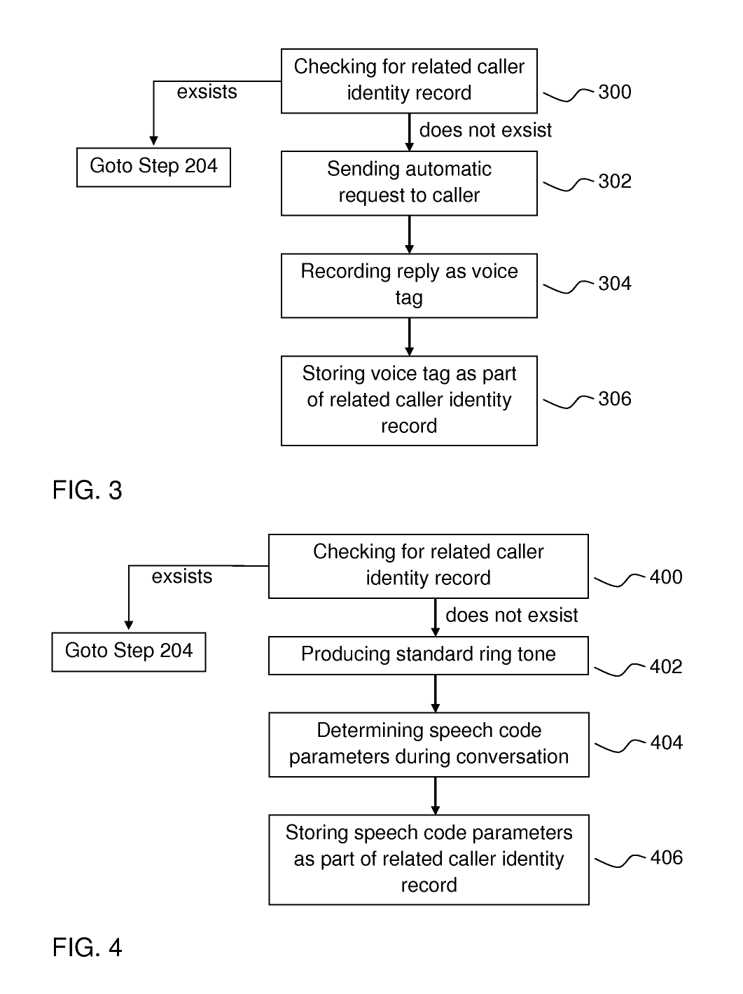

In case, no caller identity record relates to the ascertained Caller ID, a new record may be compiled. The compilation of the record may include an auto recording of the caller's voice. FIG. 3 illustrates this method. In a first step 300, an incoming Caller ID is compared to the existing caller's records. If a related caller's record exists, a method as e.g. illustrated by FIG. 2 is performed. If no existing caller's record relates to the Caller ID, an automatic reply is sent to the caller in step 302. The reply confers a request for the caller's name or other statement of identification. An according reply is received in step 304 and stored either in the caller identity record or in a temporary storage. The later modification may allow for a further processing of the incoming information, including a signal processing such as detection and eras ion of silent intervals; determination of according speech parameters; speech recognition to save the caller's identity as speech pattern, etc. The signal processing may as well include steps like data compression or data conversion to a different format, so to allow for efficient data storage. In consequence, a caller identity record related to the identity of the caller is created and stored in a memory unit in step 306.

Once, a Caller Identity record relates to the caller ID, an according audio sequence may be produced. The production may involve playing a stored audio sequence or producing an according speech sequence of the caller's name. It may also involve the production of the telephone number of the incoming call using voice characteristics of the caller's voice. The reproduction of a telephone number may be customized to the user's preference, e.g. by grouping numbers, adding pauses, playing or suppressing regional codes, etc.

FIG. 4 illustrates another method of compiling the caller identity record. In a first step 400, an incoming Caller ID is compared to the existing caller's records. If no related caller identity record is found a standard ring tone is produced at step 402, thus indicating to the user, that a caller having an identity not related to a phone book entry is calling. If the user accepts the call, a conversation will take place. During the conversation, a caller identity record is produced in step 404. This may either be performed by recording an audio sequence of the first words pronounced by the caller or by recording voice characteristics of the caller during the conversation. The audio sequence and the speech characteristics and the Caller ID may be saved as caller identity record in step 406.

In an exemplary devolution of the described methods, someone calls a user on his communication device, such as mobile phone. If his identity does not match to a phonebook entry, he is first requested to pronounce his name as caller. His reply is automatically recorded and saved as voice ID data. In a normal response, a caller will typically reveal his identity at the beginning of a conversation for identification. The recording may therefore as well be recorded at the beginning of a conversation if the user accepts an unidentified call. The caller identity record may thus be created without initiating an automatic request to the caller. The caller identity record is stored in a memory. At the end of the call, the user may decide whether keep the caller identity record or not as part of his phone book.

By this method, a new and creative Voice Caller identification system is presented. Within the system the caller's own voice is used to form a voice tag in the receiving terminal device. Thus, the identification of the caller is enhanced, since the user may identify the caller not just by his name or telephone number but as well by his voice. This may by advantageous in many situations, e.g. while accepting a call in a driving car and being distracted by traffic. As well in the context of tonal languages, such as Chinese, using the caller's voice may ascertain the right pronunciation of a name and avoids interference, such as in the case of a standard speech generator.

### CONCLUSION

Although embodiments for the described system with output power control have been described in language specific to structural features and/or methods, it is to be understood that the appended claims are not necessarily limited to the specific features or methods described. Rather, the specific features and methods are disclosed as exemplary implementations for terminal devices.

What is claimed is:

1. A method for indicating the identity of a caller in a telecommunication system, comprising:
receiving an incoming call initiated by a caller;
ascertaining the caller identity;
selecting a caller identity record comprising characteristics of the caller's voice; and
producing an audio signal based on the record.

2. The method according to claim 1, wherein:
wherein the caller identity record comprises a voice recording.

3. The method according to claim 1, wherein
the caller identity record comprises a set of speech coding parameters.

4. The method according to claim 1, comprising:
checking for a caller identity record and indicating the existence of the caller identity record.

5. The method according to claim 4, comprising:
producing a caller identity record if no caller identity record exists.

6. The method according to claim 5, comprising:
storing a voice tag as caller identity record.

7. The method according to claim 5, comprising:
determining a set of speech coding parameters; and
storing the speech coding parameters as part of a caller identity record.

8. A system for indicating the identity of a caller in a telecommunication system, comprising:
a caller identity date storage for storing a caller identity record;
a terminal receiving an incoming call signal initiated by a caller, the incoming call signal comprising a Caller ID information;
a circuitry for ascertaining the caller identity from the Caller ID information;
a selection unit for selecting a related caller identity record comprising characteristics of the caller's voice; and
a voice generator for producing an audio signal based on the record.

9. The system according to claim 8,
wherein the voice generator comprises a loudspeaker.

10. The system according to claim 8,
wherein the voice generator comprises a speech generator.

11. The system according to claim 8, comprising:
a determination unit that determines the existence of a related caller identity record.

12. The system according to claim 11, comprising:
a voice tag recorder to record an audio sequence as part of a related caller identity record.

13. The system according to claim 11, comprising:
a unit for determining speech parameters of a caller's voice.

14. A method of creating a caller identity record, comprising:
receiving an incoming call initiated by a caller;
Checking for the existence of a caller identity record;
Sending an automatic request for pronouncing an identification to the caller;
Recording an audio sequence of a received reply; and
Storing the audio sequence as part of a related caller identity record.

15. A method of creating a caller identity record, comprising:
receiving an incoming call initiated by a caller;
checking for the existence of a caller identity record;
recording at least a part of a conversation
determining speech parameters of the caller's voice; and
storing the speech parameters as part of a related caller identity record.
